(19) United States
(12) Patent Application Publication
(10) Pub. No.: US 2014/0236852 A1
(43) Pub. Date: Aug. 21, 2014

(54) SYSTEM AND METHOD OF DETERMINING WORKER SKILLS AND EXPERIENCE

(71) Applicant: Phillip Joseph Emmerton, Chandler (AU)

(72) Inventor: Phillip Joseph Emmerton, Chandler (AU)

(21) Appl. No.: 14/130,469

(22) PCT Filed: Jun. 28, 2012
(86) PCT No.: PCT/AU2012/000785

§ 371 Date: Apr. 18, 2014

(30) Foreign Application Priority Data
Jul. 1, 2011 (AU) 2011902630

(51) Int. Cl. G06Q 10/10

(52) U.S. Cl. CPC G06Q 10/1053
USPC 705/321

(57) ABSTRACT

A method of determining worker skills and experience including the steps of: transmitting from a server a first interview question to a worker based on a job type; receiving at the server an answer to the first interview question; transmitting from the server a further interview question to the worker based on both the job type and the answer to the first interview question; receiving at the server an answer to the further interview question; and storing on the server the answer to the first interview question and the answer to the further interview question in a worker profile.

### FIELD OF THE INVENTION

This invention relates generally to a system and method of determining worker skills and experience. In particular, the invention relates to a method and system for determining whether a worker possesses required skills and experience for a job.

### BACKGROUND OF THE INVENTION

Many employers often require casual labour for a job. For example, in the truck driving industry employers often enlist the services of a recruitment agency in order to find suitable drivers to drive particular trucks and routes. In order to find the most suitable driver for a job, the recruitment agency may review a series of Curriculum Vitaes (CVs) in order to determine whether a driver has the required skills, qualifications and experience for the job.

However, in many cases a CV will not include sufficient detail to determine whether a worker has the necessary skills, qualifications and experience for a job. For example, although a CV may detail previous truck driving jobs, it may lack sufficient detail to determine whether the worker can drive a particular type of truck, or can operate certain types of restraints for a hauled load. Thus it may be necessary to contact the worker to ask further questions, which cannot be answered from information on the CV, before determining whether the worker is appropriate for a job. This takes extra time and money to carry out, and can be a significant labour burden on a labour hire agency.

Furthermore, workers often abbreviate their CVs in order to provide information in a concise format, and information that could be very valuable to an employer is not included. Also, for some manual labour work, highly skilled workers may be well suited for particular jobs, but due to poor writing skills or poor CV preparation skills such workers are unable to prepare an effective CV and are thus not hired.

US patent publications US 2007/0088601 and US 2006/0257840 both disclose methods of conducting interviews over the Internet. However, these systems use standard questions which require further evaluation which takes extra time.

There is therefore a need for an improved system and method of determining worker skills and experience.

The reference to any prior art in this specification is not, and should not be taken as, an acknowledgement or any form of suggestion that the prior art forms part of the common general knowledge in Australia or elsewhere.

### OBJECT OF THE INVENTION

It is an object of some embodiments of the present invention to provide consumers with improvements and advantages over the above described prior art, and/or overcome and alleviate one or more of the above described disadvantages of the prior art, and/or provide a useful commercial choice.

### SUMMARY OF THE INVENTION

In one form, although not necessarily the only or broadest form, the invention resides in a method of determining worker skills and experience including the steps of:

transmitting from a server a first interview question to a worker based on a job type;

receiving at the server an answer to the first interview question;

transmitting from the server a further interview question to the worker based on both the job type and the answer to the first interview question;

receiving at the server an answer to the further interview question; and

storing on the server the answer to the first interview question and the answer to the further interview question in a worker profile.

Preferably, the method includes creating, at the server, a Curriculum Vitae based on the answers to the first interview question and the further interview question.

Preferably, the first and further interview questions are related to one or more of a skill, a qualification and an experience of the worker.

Preferably, the method includes the step of matching a job based on the worker's previous experience.

Preferably, a rating is applied to the worker profile based on answers to the interview questions.

Preferably, the method further includes the step of matching job attributes to a worker profile at the server, and transmitting from the server one or more worker profiles that most closely match the job attributes.

Preferably, the job attributes include a qualification and a skill required for a job.

Preferably, the method further includes the step of performing an induction on-line.

Suitably, a record of the induction is stored in the worker profile.

Preferably, the induction includes one or more of a question, a video and a presentation.

Preferably, the method includes the step of performing a skills assessment based on the answers to the first and further interview questions.

Preferably, the method includes the step of determining further skills based on interviews performed with other workers in the same profession and sending a list of suggested skills to the worker.

In another form, the invention resides in a system for determining worker skills and experience including:

a server connected to the internet, the server including:

a memory coupled to a processor, wherein the memory includes computer readable program code components configured to cause:

transmitting a first interview question to a worker based on a job type;

receiving an answer to the first interview question;

transmitting a further interview question to the worker based on both the job type and the answer to the first interview question;

receiving an answer to the further interview question; and

storing the answer to the first interview question and the answer to the further interview question in a worker profile.

Preferably, the program code components further include the step of creating a Curriculum Vitae based on the answers to the first interview question and the further interview question.

Preferably, the interview questions are related to one or more of a skill, a qualification and an experience of the worker.

Preferably, the method includes the step of matching a job based on the worker's previous experience.

Preferably, a rating is applied to the worker profile based on answers to the first and further interview questions.

Preferably, the program code components further include the step of matching job attributes to a worker profile and transmitting one or more worker profiles that most closely match the job attributes.

Preferably, the job attributes include a qualification and a skill required for a job.

Preferably, the worker profile includes a willingness and/or an eagerness to perform a skill or job.

Preferably, the program code components further include the step of performing an induction on-line.

Suitably, a record of the induction is stored in the worker profile.

Preferably, the induction includes one or more of a question, a video and a presentation.

Preferably, the program code components further include the step of performing a skills assessment based on the answers to the interview questions.

Preferably, the program code components further include the step of determining further skills based on interviews performed with other workers in the same profession and sending a list of suggested skills to the worker.

### BRIEF DESCRIPTION OF THE DRAWINGS

An embodiment of the invention will be described with reference to the accompany drawings in which:

FIG. 1 is a block diagram illustrating a system of determining worker skills and experience according to an embodiment of the present invention;

FIG. 2 is a flow diagram showing the steps of a method of determining worker skills and experience according to an embodiment of the present invention;

FIG. 3 is a screen shot of a qualifications web page according to an embodiment of the present invention;

FIG. 4 shows a screen shot of an employment web page according to an embodiment of the present invention;

FIG. 5 shows a screen shot of a job type web page according to an embodiment of the present invention;

FIG. 6 shows a screen shot of skills web page according to an embodiment of the present invention;

FIG. 7 shows a screen shot of a further questions web page according to an embodiment of the present invention;

FIG. 8 shows a screen shot of a summary web page according to an embodiment of the present invention;

FIG. 9 shows a screen shot of a compatible jobs web page according to an embodiment of the present invention;

FIG. 10 shows a screen shot of an additional skills web page according to an embodiment of the present invention;

FIG. 11 shows a screen shot of a multiple-choice assessment web page according to an embodiment of the present invention;

FIG. 12 shows a screen shot of a video assessment web page according to an embodiment of the present invention;

FIG. 13 shows a screen shot of a skills overview web page according to an embodiment of the present invention;

FIG. 14 shows a screen shot of a calendar web page according to an embodiment of the present invention;

FIG. 15 shows a screen shot of a day view web page according to an embodiment of the present invention;

FIG. 16 shows a screen shot of a new order web page according to an embodiment of the present invention;

FIG. 17 shows a screen shot of skill page according to an embodiment of the present invention;

FIG. 18 shows a screen shot of a qualification requirements web page according to an embodiment of the present invention;

FIG. 19 shows a screen shot of a worker match web page according to an embodiment of the present invention;

FIG. 20 shows a screen shot of a worker's full profile web page according to an embodiment of the present invention;

FIG. 21 shows a screen shot of an interactive web page according to an embodiment of the present invention;

FIG. 22 shows a screen shot of a pricing structure web page according to an embodiment of the present invention;

FIG. 23 shows a screen shot of a an alternative embodiment of a skills selection web page;

FIG. 24 shows a screen shot of a drop down list of the alternative embodiment of a skills selection web page of FIG. 23; and

FIG. 25 shows a screen shot of an add skill web page according to an embodiment of the present invention.

### DETAILED DESCRIPTION OF THE PREFERRED EMBODIMENT

Elements of the invention are illustrated in concise outline form in the drawings, showing only those specific details that are necessary to understanding the embodiments of the present invention, but so as not to clutter the disclosure with excessive detail that will be obvious to those of ordinary skill in the art in light of the present description.

In this patent specification, adjectives such as first and second, left and right, front and back, top and bottom, etc., are used solely to define one element from another element without necessarily requiring a specific relative position or sequence that is described by the adjectives. Words such as “comprises” or “includes” are not used to define an exclusive set of elements or method steps. Rather, such words merely define a minimum set of elements or method steps included in a particular embodiment of the present invention. It will be appreciated that the invention may be implemented in a variety of ways, and that this description is given by way of example only.

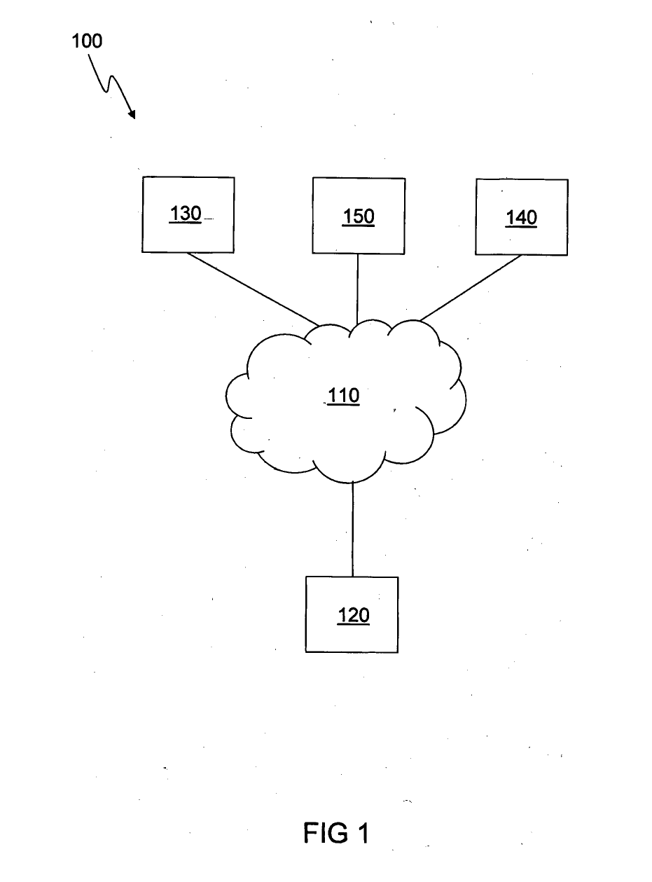

FIG. 1 is a block diagram showing a system 100 for determining worker skills and experience, according to an embodiment of the present invention. A computer in the form of a server 120 is connected to the Internet 110, to which users, such as a worker 130, an employer 140 and a managing agency 150, have access. The users may access the server 120 using a web browser installed on a computer.

The server 120 includes a memory coupled to a processor, and the memory includes computer readable program code components. The program code components are in the form of software installed on a computer readable medium, for example on a hard disk, a random access memory (RAM), or any other applicable computer readable medium. The program code components perform the method of the present invention.

The present invention allows employers 140 to search for workers 130, and for workers 130 to apply for jobs posted by the employer 140, using a website managed by the managing agency 150. The employer 140 may pay a fee to the managing agency 150 when a worker 130 is hired using the website. In this specification, the term employer 140 is used to indicate that the worker 130 performs a job for the employer 140. The managing agency 150 may or may not pay the worker's wages. Furthermore, the worker 130 and the employer 140 may be in direct contact using the present invention. Alternatively, the worker 130 and the employer 140 may be in contact through a recruitment agency.

A worker profile is created and stored on the server 120 by asking a series of interview questions to the worker 130. An answer to a first interview question may lead to a further interview question that is related both to the answer provided to the first interview question and a job type. Job attributes are defined by the employer 140, to determine an ideal worker for the job.

The server 120 searches worker profiles that most closely match the job attributes and returns a list of the worker profiles of the most suitable worker 130 or workers 130.

When the employer 140 selects a suitable worker 130 or workers 130, the employer 140 may contact a worker 130 directly, or the employer 140 may request the managing agency 150 to contact the worker 130.

An advantage of the present invention is that the required level of detail is collected from a worker 130 for a job without the worker 130 needing substantial CV preparation skills about what information to provide, and without the employer 140 needing to invest substantial time to determine the right questions to ask the worker 130.

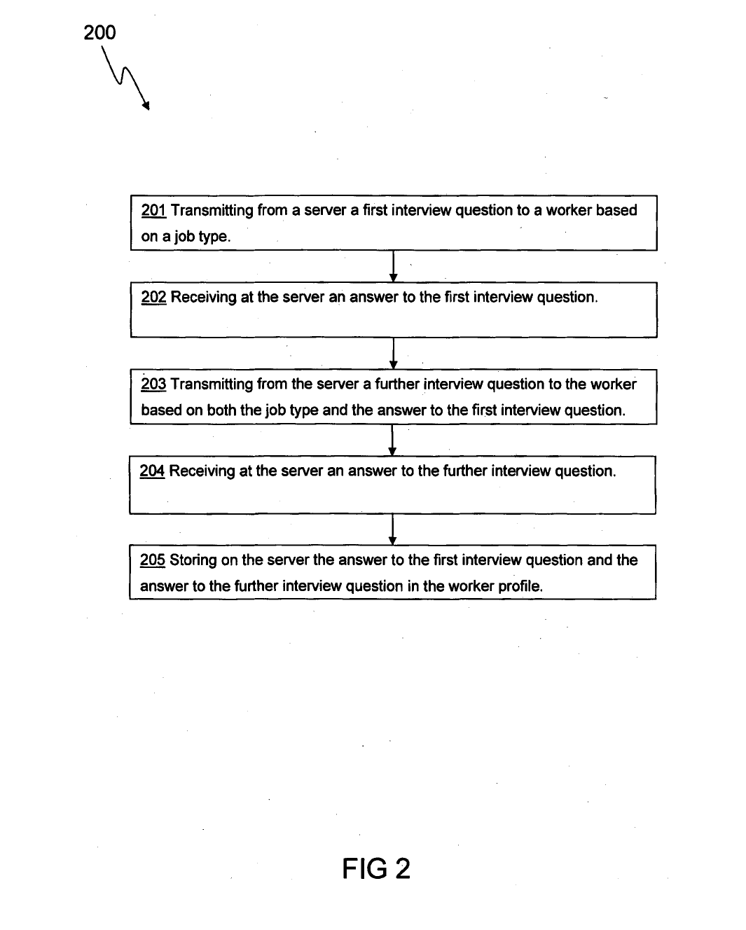

FIG. 2 is a flow diagram showing the steps of a method of selecting a labour resource according to an embodiment of the present invention. At step 201 the server 120 transmits a first interview question to a worker based on a job type.

At step 202, the server 120 receives an answer to the first interview question.

At step 203, the server 120 transmits a further interview question to the worker based on both the job type and the answer to the first interview question.

At step 204, the server 120 receives an answer to the further interview question.

At step 205, the server 120 stores the answer to the first interview question and the answer to the further interview question in the worker profile.

Although the process is exemplified above where the server 120 receives an answer before providing the next question(s), it should be appreciated that the answer does not necessarily have to be sent back to the server 120 before the next question is sent from the server 120. The server 120 may send many possible questions and answers which may be stored on the worker's computer and accessed at the worker's computer in order to speed up the process.

A worker 130 may access the server 120 using a web browser installed on a computer, or using an application stored on any computing device such as a tablet computer, Smartphone or any other suitable device. Initially, the worker 130 logs onto the server 120 by submitting a username and a password. If the worker 130 is new to the system, the worker 130 enters a first name, last name, email address and a password. Alternatively, the server 120 may send a password to the worker 130 (which are stored in the worker profile) and is directed to a terms and conditions page. Alternatively, the worker 130 may click on an acceptance box to accept the terms and conditions. Upon acceptance of the terms and conditions, the worker 130 is prompted to enter the type of job the worker 130 is interested in applying for, and whether he or she is interested in a casual position, a permanent position or both. In the present embodiment, consider that the worker 130 is seeking a casual truck driving job. However, it should be appreciated that the present invention may be tailored to any profession, such as nurses, builders, excavator operators and engineers to name a few. Furthermore, the present invention may be used to find workers 130 for permanent positions.

The worker 130 answers a series of interview questions to determine the worker's skills, experience, qualifications and previous employment, the answers to which are stored in a worker profile on the server 120.

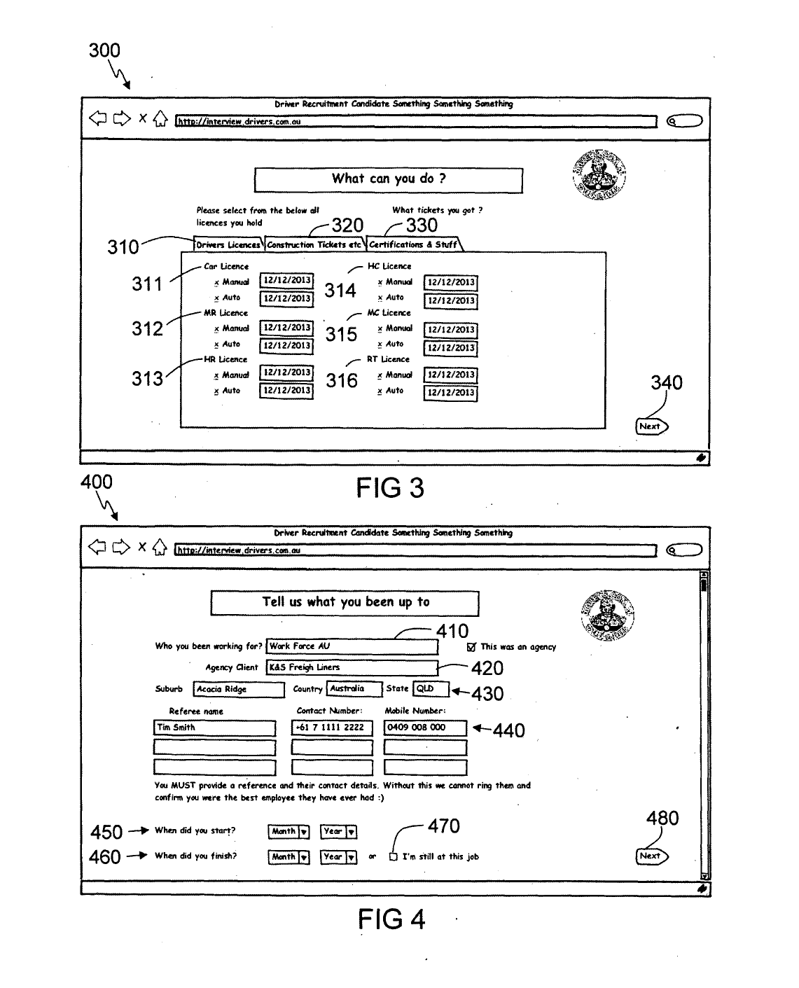

In one embodiment, the interview questions are designed to determine the worker's qualifications relating to the job or the industry the worker 130 is interested in. FIG. 3 shows a screen shot 300 of a qualifications web page according to an embodiment of the present invention.

Firstly, the worker 130 selects types of vehicle 310 the worker 130 is licensed to drive, together with an expiry date of the relevant license. Further details may include whether the worker 130 is licensed to drive either a manual or an automatic transmission. For example the license may be for a car 311, medium rigid (MR) truck 312, heavy rigid (HR) truck 313, heavy combination (HC) truck 314, medium combination (MC) truck 315 or a road train (RT). In addition, the worker 130 may enter details of construction site qualifications 320 or other certifications 330 they may have. In addition, the worker 130 may upload documentary evidence of the qualifications that may be stored in the worker profile. Once the worker 130 has entered all relevant information, the worker 130 clicks on a next button 340, and the information is stored in the worker profile.

Next the worker 130 answers interview questions relating to the worker's previous employment. FIG. 4 shows a screen shot 400 of a first screen of an employment web page according to an embodiment of the present invention. The worker 130 enters details of previous or current employment, such as an employer name 410, an agency name 420 (if applicable), a location 430 of the employer 140 or agency, a reference name and contact details 440 of the employer 140 or agency. In addition further details of such as start and finish dates 450, 460, respectively, may be entered. A check box 470 may be ticked if the worker 130 is still with that employer 140. When complete, the worker 130 clicks a next button 480 and the worker's previous employment history is stored in the worker profile on the server 120.

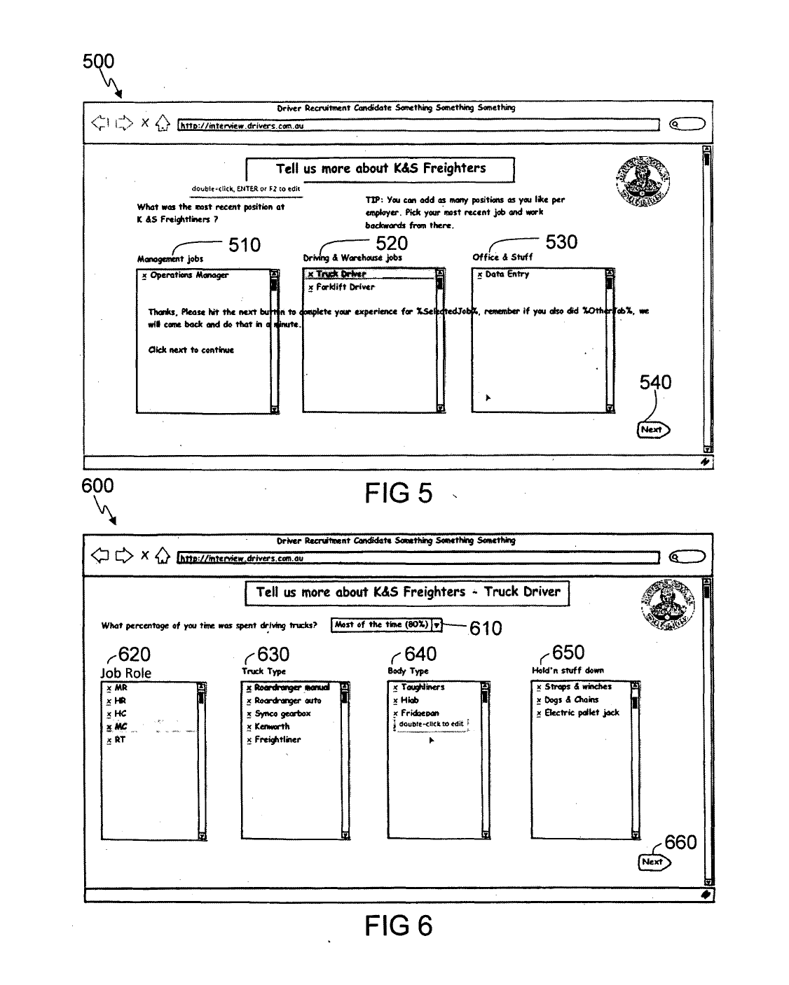

Next the worker 130 selects the type or types of job they have performed at the employer 140 from FIG. 4. FIG. 5 shows a screen shot 500 of a job type web page according to an embodiment of the present invention. The worker 130 selects the most relevant job type or types, such as a management job 510, a driving job 520 and an office job 530. From FIG. 4, the worker 130 selected a truck driver. Once the worker 130 has made a selection, a popup window explains the position in detail, or the worker 130 may click on the selection to see more detail of the position, to ensure the worker 130 has selected the right job type. When the worker 130 has made a selection or multiple selections, the worker 130 clicks on a next page button 540 to store the job details in the worker profile and proceed to the next step.

Additionally, interview questions may relate to skills the worker 130 may have, which may relate to the answers provided regarding qualifications the worker 130 possesses from FIG. 3. FIG. 6 shows a screen shot 600 of a skills web page according to an embodiment of the present invention. From the job type entered in FIG. 5, the server 120 determines which questions to ask from a database on the server 120 relating to that job type. In the present embodiment, the server 120 determines the most applicable questions for truck drivers. Each subsequent question depends on an answer to a previous question.

For example, in one embodiment, the worker is asked to choose a type of equipment that he or she operated at the previous employer or job role, by selecting from a job role field 620. From the job role selected, the server 120 determines and populates a truck type field 630 from a look up table in a database. Similarly, once the worker 130 has selected a truck type, a body type field 640 may be populated by the server 120, which determines the type of freight that can be carried, or with which the worker 130 has had experience. Finally, once the body type 640 has been selected, the server 120 populates a restraint type from a restraint type field 650 and the restraint type that the worker 130 has experience of using is selected. When the worker 130 clicks on a next button 660 the selections are stored in the worker profile on the server 120.

In addition, the worker 130 selects an amount of time the worker 130 spent driving trucks for the employer 140 of FIG. 4 from a drop down menu 610. In one embodiment, the worker 130 selects a percentage of time that was spent driving trucks. However it should be appreciated that the amount of time may be displayed as a number of hours or any suitable unit. From this, the number of hours driving trucks may be calculated as a percentage of their total time employed, and may be expressed as a number of months.

In another embodiment, the worker 130 may enter a new skill if the skill is not listed.

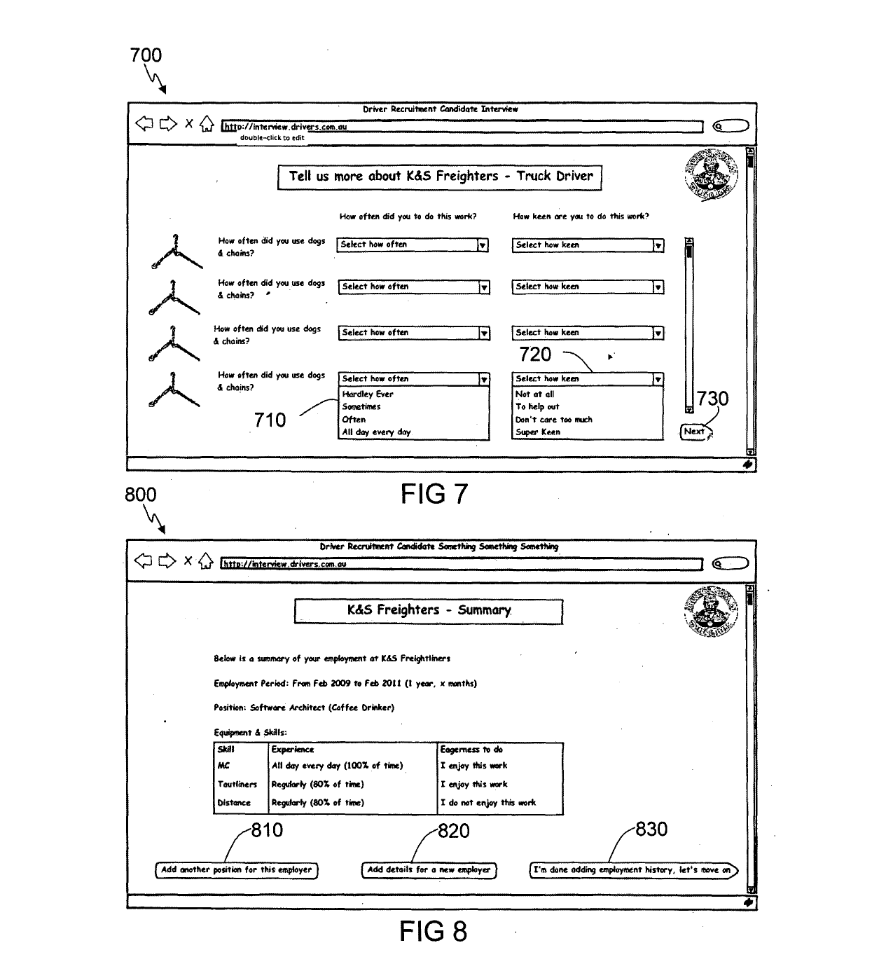

Based on the answer or answers provided to the previous questions, the server 120 may select yet further questions to display to the worker 130. FIG. 7 shows a screen shot 700 of a further questions web page according to an embodiment of the present invention. For example, the worker 130 may have answered that he or she has experience with the restraint type of dogs and chains. Thus the server 120 presents questions relating to the use of dogs and chains. In one embodiment, the question relates to how often 710 the worker 130 has used dogs and chains, and how keen 720 the worker 130 is to use dogs and chains. Once the worker 130 has answered all of the further questions, the worker 130 clicks on a next page icon 730 and the answers to the further questions are stored in the worker profile.

In addition, some questions may ask the worker 130 to provide information such as previous insurance claims, accidents, remuneration, reasons for leaving the job, aspects that the worker 130 liked about the job and aspects the worker 130 did not like about the job. Remuneration information may be used to trend pay rates across different geographical regions and types of work.

Once the worker 130 has entered all the details relating to a previous job, a summary may be displayed as shown in FIG. 8. FIG. 8 shows a screen shot 800 of a summary web page according to an embodiment of the present invention. The summary web page details skills, experience and an eagerness of the work performed for that employer 140. The worker 130 may also add other roles completed at the same employer 140 by click on a new role button 810 and answer questions relating to the other roles. Furthermore, the worker 130 may add to their employment history by adding other employers 140 by clicking on a new job button 820. Once a complete employment history has been entered, the worker 130 clicks on a next page button 830 and the employment history is stored in the worker profile. From the previous work experience, the server 120 may determine a level of skill the worker 130 has for a type of job.

In another embodiment, answers provided to questions related to the worker's previous employment may be used to determine the worker's skills. From the skills the server 120 may determine jobs that may be suited to the worker 130. The jobs may be related to truck driving or any job that match the worker's skills. Additionally, a job may need skills, A, B and C. Thus the interview questions may be tailored to determine whether the worker 130 has the skills A, B, C, and whether the worker 130 has the necessary qualifications to perform skills A, B, C. Furthermore, the server 120 may determine whether the worker 130 has performed the necessary inductions related to skills A, B, C. If the worker 130 has not performed the necessary inductions, the system may perform the inductions on-line. In addition, the system 100 may determine whether the worker 130 has the necessary qualifications required for a particular skill.

Each time the worker 130 completes a stage of the interview, the server 120 searches for jobs that may match the worker's profile. These jobs are matched on a skill and eagerness of the worker 130 to do the job. However it should be appreciated that the jobs may also be matched using other factors such as a location where the worker 130 is prepared to work, past feedback or any other suitable factor. As more work experience is entered, a greater number of jobs are likely to be displayed. It should be appreciated that the worker 130 does not need to complete all stages of the interview process in order for the server 120 to determine compatible jobs. It should be appreciated that the server 120 may also display compatible jobs during intermediary stages of the interview process. After each stage, the server 120 may update the most compatible jobs and display the jobs to the worker 130. For example the server 120 may show compatible jobs once any one or more of a worker's qualifications, skills and previous work experience have been entered.

Furthermore, the system 120 may determine additional training or qualifications the worker 130 may need, or may be useful, for a particular job. In addition, the server 120 may determine a list of organisations that may provide the training or to obtain assistance from government organisations for example.

The server 120 may send further questions to the worker 130 based on previous answers to determine a worker's willingness to relocate of acquire additional skills. Depending on the answers provided, the server 120 may determine further jobs that may suit the worker.

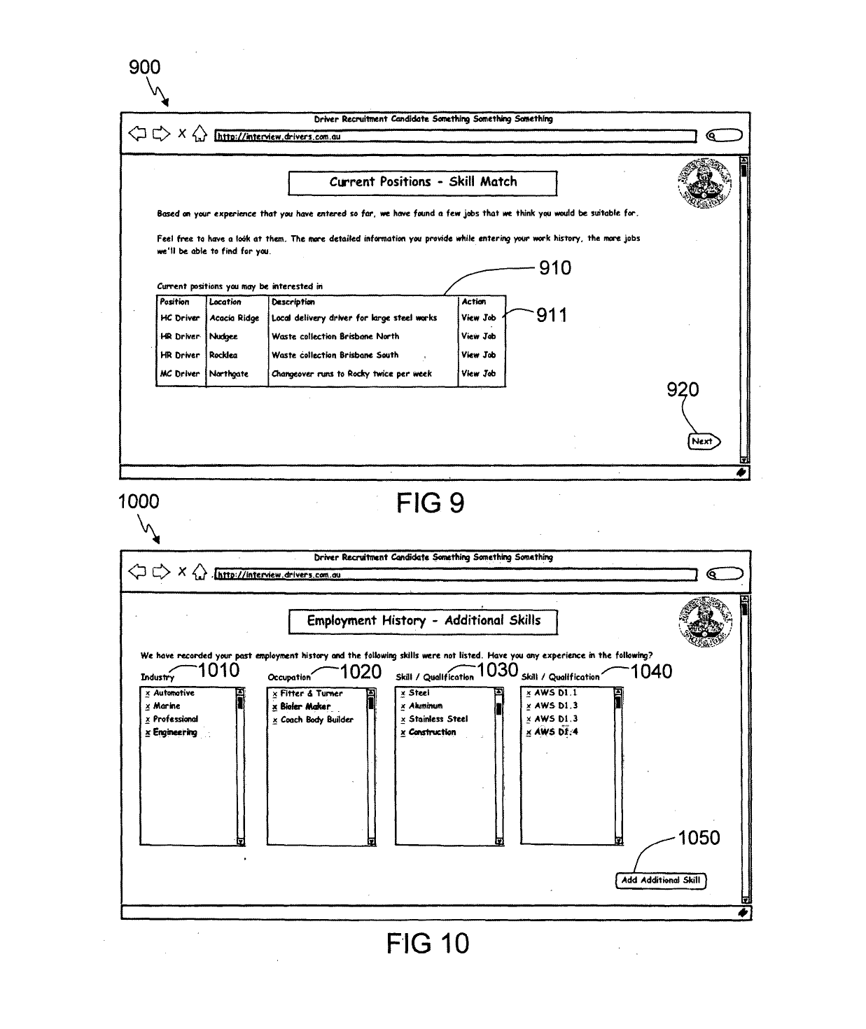

FIG. 9 shows a webpage 900 of a compatible jobs web page according to an embodiment of the present invention. The compatible jobs web page displays a table 910 of jobs that closely match job attributes of a job. If a worker 130 sees a job that he or she is interested in, he or she clicks on a view job button 911, or else clicks on a next button 920.

The interview questions may also include work experience of a different job type to truck driving, which may be advantageous to potential employers. For example, the worker 130 may be a qualified boiler maker with several welding tickets. These extra qualifications may be useful to a metal working company looking for a truck driver. Similarly, an answer to one question may lead to further questions that are related to the answer of a previous question and the job type. In addition, the server 120 may determine or suggest additional skills, related to the previous employment, that have not been selected by the worker 130. From the suggestions, the worker 130 may select one or more skills that he or she has experience in.

FIG. 10 shows a screen shot 1000 of an additional skills web page according to an embodiment of the present invention. A worker 130 selects a job type from an industry selection box 1010. Similarly to FIG. 6, occupation box 1020, skills box 1030 and qualification box 1040 fields are blank when the web page is first displayed. Once an answer in one box has been selected, the box immediately to the right is populated depending on the answer. The worker 130 selects a relevant industry from box 1010, and the occupation box 1020 is populated according to the industry selected from box 1010. When an occupation is selected from the occupation box 1020, a list of appropriate skills is populated in the skills box 1030. Finally, when a skill is selected in box 1030, the qualification box 1040 is populated appropriate qualifications relating to the skill. The worker 130 continues to add further skills as appropriate which are stored in the worker profile.

Additional questions may be asked and sent by the server 120 relating to the worker's availability and the worker's willingness to work overtime for example. Should the employer 140 wish to contact the worker 130 directly, the employer may pay an additional fee to the managing agency 150, or the option may be made available with a subscription, the answers to which are stored in the worker's profile. Alternatively the employer 140 wish to ask the worker 130 additional questions directly, by contacting the worker 130 directly, by paying an additional fee in order to view the worker's contact details. The answers provided by the worker 130 may be entered by the employer and added to the worker's profile and stored on the server.

In some embodiments, the server 120 may be configured to send behavioural analysis questions to the worker 130. For example the server 120 may send questions to determine the worker's response when put in a certain situation. For example, the worker 130 may be asked how he or she may deal with an angry customer. The behavioural questions may be in a multiple choice format, or using free text. In the case of free text, the server 120 may be configured to interpret the text, for example the server 120 may interpret the free text and convert the answer into a pre-determined format. In an alternative to using free text the server 120 may use voice recognition to convert spoken words to text. It should also be appreciated that the server 120 may use voice recognition to interpret other spoken answers provided by the worker 130.

Once the worker 130 has completed entering his or her skills and experience, the server 120 may formulate the skills and experience into a CV. The worker 130 may email the CV, create a PDF of the CV or print the CV.

Once the employment history has been completed, the worker 130 may then undergo a skills assessment. The questions asked during the skills assessment may be directly related to the answers provided in the interview questions and the job type. For example, if the worker 130 answered that they had experience of using tautliners, the assessment may include questions relating to tautliners. For driving jobs, the assessment questions may be directly related to various road rules and laws relating to trucks. Answering the questions correctly confirms the worker's understanding and may also form part of an induction, which is described later.

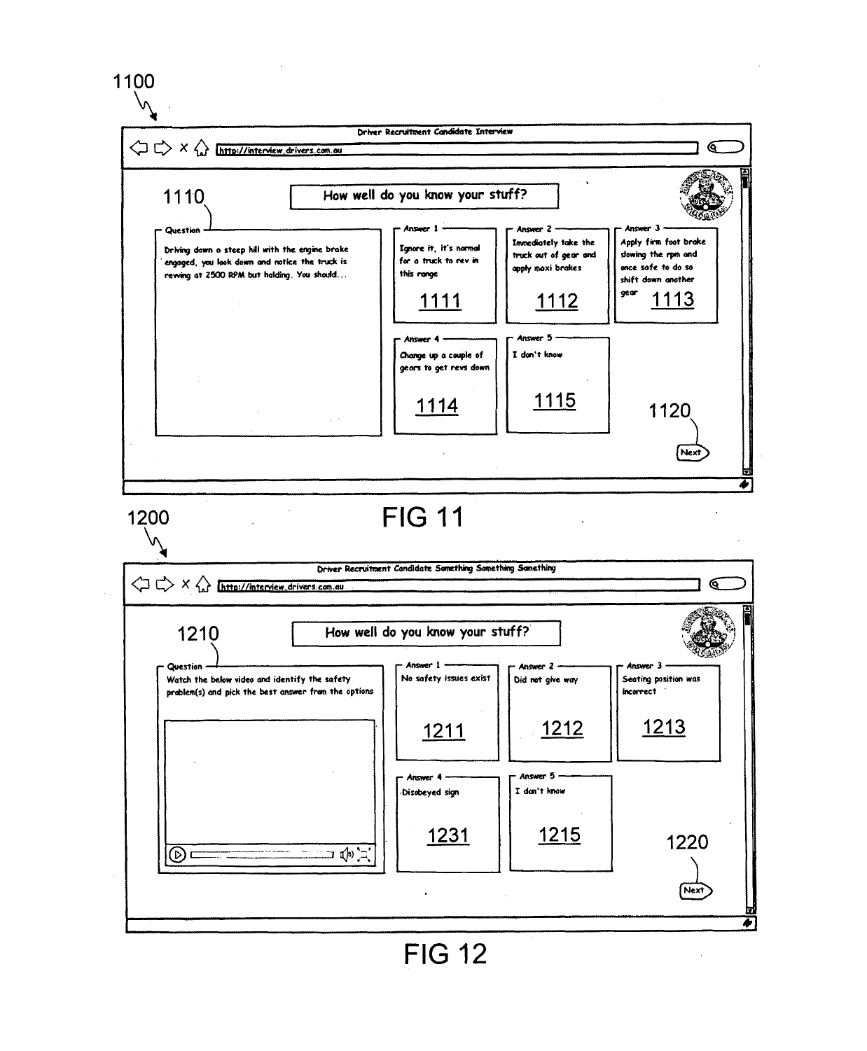

FIG. 11 shows a screen shot 1100 of a multiple-choice assessment web page according to an embodiment of the present invention. The multiple-choice assessment web page includes a question 1110 and a plurality of multiple-choice answers 1111, 1112, 1113, 1114, 1115. The worker 130 selects one or more answer 1111, 1112, 1113, 1114, 1115 and clicks on a next button 1120. The server 120 records the worker's answer in the worker profile. This process is repeated until all applicable questions have been answered.

Apart from multiple choice questions, the assessment may include text, video, and images. FIG. 12 shows a screen shot 1200 of a video assessment web page according to an embodiment. In one embodiment the worker 130 watches a video 1210 and answers a question related to what he or she has seen in the video 1210 by selecting one or more multiple-choice answers 1211, 1212, 1213, 1214, 1215. However it should be appreciated that written answers, or any other form of assessment may be used. When the worker 130 has selected an answer or answers, the worker 130 clicks on a next button and the answer and a result are recorded in the worker's profile.

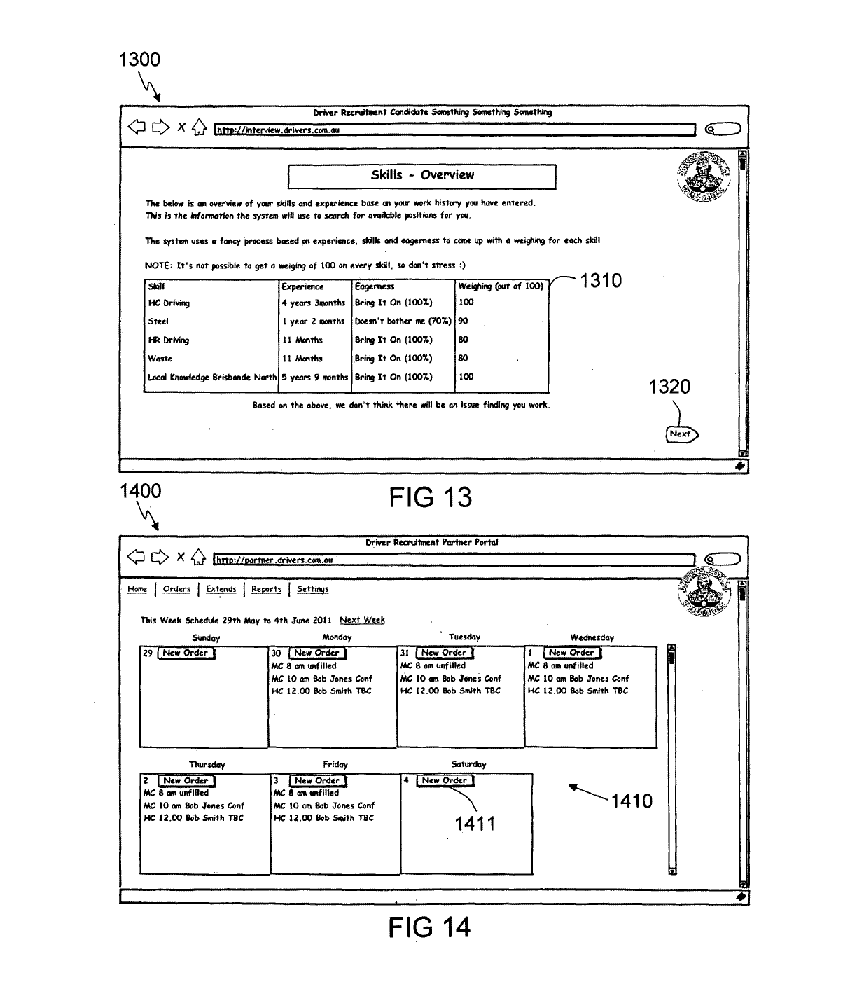

Once the worker 130 has completed the assessment, the server 120 may provide an overview and a rating of the worker's skills based on the interview questions and the assessment as shown in FIG. 13. FIG. 13 shows a screen shot 1300 of a skills overview web page according to an embodiment of the present invention. A table 1310 is displayed to the user listing each skill and a level of experience for that skill, and an eagerness to do the skill. From the level of experience, willingness and the eagerness to do a job, the server 120 may calculate a score or a weighting for each skill. To continue, the worker 130 presses a next button 1320. In addition, each skill may individually have feedback, which is used to calculate an overall rating.

Workers 130 may also undertake inductions online. The induction may be a general induction, for example on using a fire extinguisher. In addition, the worker 130 may be required to undertake specific inductions for a particular task, at a particular job or a particular employer 140. Furthermore, if the worker 130 has previously performed an induction (and it is still current) the worker 130 may upload evidence that the induction has been performed.

In addition, if a worker 130 is assigned to a job, the worker 130 may be required to complete inductions in order to perform the job. This ensures the worker 130 is job ready.

Similar to the assessment, the induction may comprise questions, text, video, presentations or any other suitable material. Once a worker 130 has completed an induction, a record of the induction may be stored in the worker profile. The questions are tailored to the job type that the worker 130 is applying for.

In addition, the present invention may be used in conjunction with a resume parser stored on the server as is known in the art. The resume parser scans a physical resume and may extract data in order to pre-populate fields during the interview process. For example, the resume parser may extract personal details, including a name and address of the worker 130, and populate relevant fields.

In order to advertise a job on the website, or to find a worker 130 for a particular assignment, the employer 140 logs into the website, in the usual way. If required, the employer 140 may need to register to use the website. Once logged in, the employer 140 is presented with a calendar. FIG. 14 shows a screen shot 1400 of a calendar web page according to an embodiment of the present invention. The calendar web page shows an overview 1410 of jobs the employer 140 has previously posted and whether the jobs have been filled. In order to post a new job, the employer 140 clicks on a new order button 1411. In order to see more detail for a particular day, the employer 140 may click on a day of the week (for example clicking on Monday in FIG. 14) in order to display a day view web page.

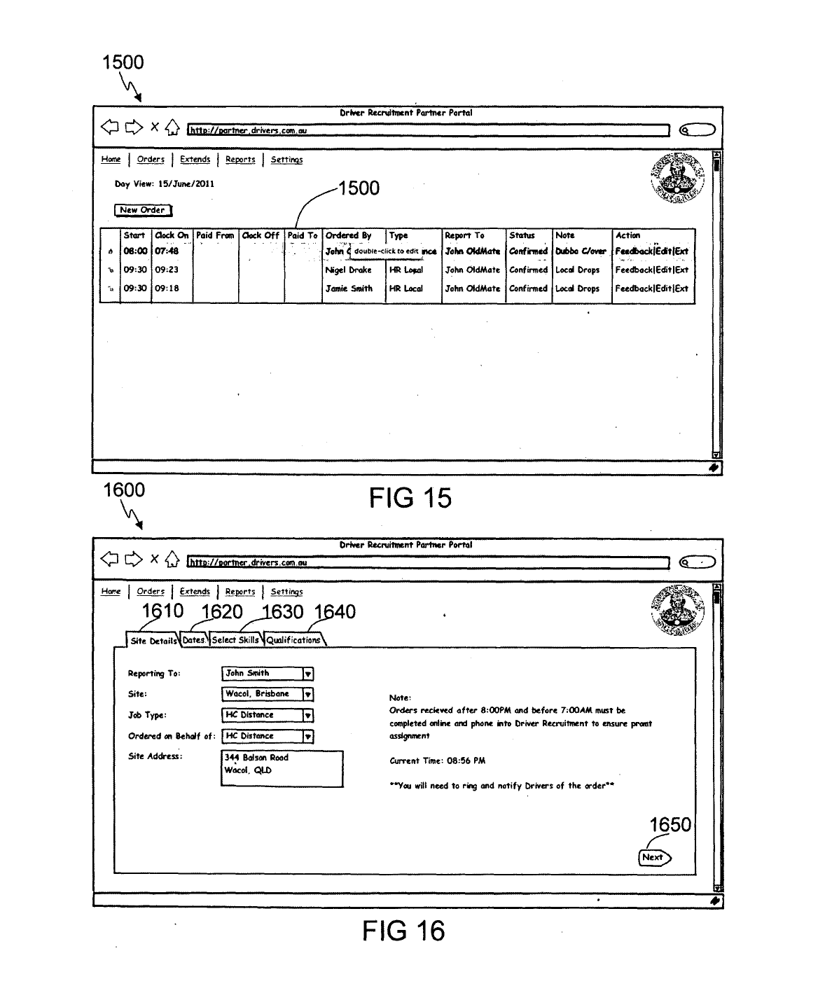

FIG. 15 shows a screen shot 1500 of a day view web page according to an embodiment of the present invention. The day view web page shows a table 1510 of job start and finish times, clock on and off times, times the worker 130 is paid from and to, who ordered the job, a type of job, a status of the job and any notes. In addition, the day view web page allows an employer 140 to extend a worker's assignment length. In addition the employer 140 may edit or confirm the worker's clock on and off times and provide feedback once the worker 130 has completed the job. The feedback may relate to timeliness, attitude and a quality of work and is stored in the worker's profile.

Furthermore, the worker 130 may identify that he or she has previously worked for an employer 140 stored on the server 120 and a previous employer 140 may provide feedback on the worker 130 even although the worker 130 has not been recruited using the present invention. A link between the worker 130 and the employer 140 may have been established in past employment, for example 15 years prior.

In order to post and place an order for a new job, the employer 140 determines job attributes. The job attributes may include the skills, qualifications and requirements of an ideal worker 130 for the job. FIG. 16 shows a screen shot 1600 of a new order web page according to an embodiment of the present invention.

FIG. 16 shows a screen shot 1600 of a new job web page according to an embodiment of the present invention. As shown in FIG. 16, the employer 140 enters general details or site details by clicking on a site details tab 1610. The site details may include a contact person, a location, a type of driving job, a company name and an address. Once the site details have been entered, the employer 140 clicks on a date tab 1620 or a next button 1650, to enter job dates and times.

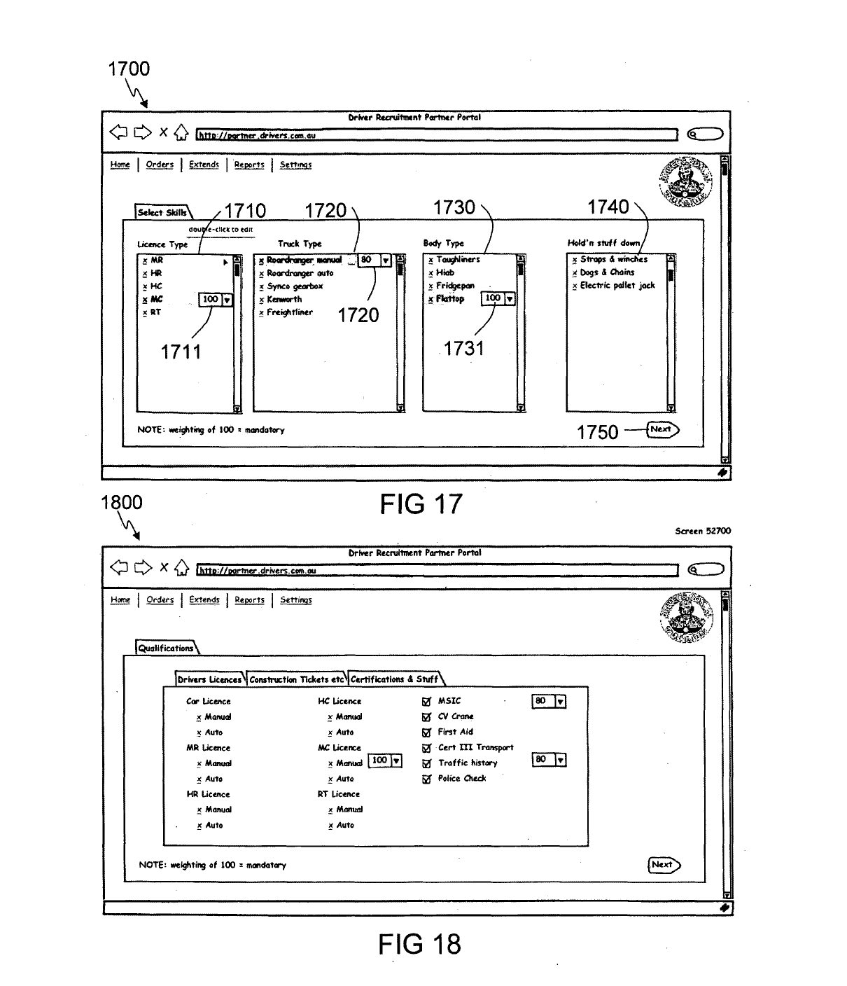

Once the dates of the job have been entered, the employer 140 clicks on a skill selection tab 1640. FIG. 17 shows a screen shot 1700 of a skill selection web, page according to an embodiment of the present invention. Similar to FIG. 6, the employer 140 selects a type of license 1610, which relates to the type of truck the worker 130 can operate, from a list that is required for the job. From the license type 1710, the server 120 determines a truck type, and displays a list of available truck types 1720. Once a truck type is selected by the employer 140, the server 120 determines a body type 1730, which determines the type of freight that can be carried, or the worker 130 has had experience with. From the body type, the server 120 determines a type of restraint 1740.

The skills requirements may be given a desirability factor. Mandatory skills 1711, 1731 are indicated by a 100. Zero indicates a low desirability for that skill, and 99 indicates that the skill is highly desirable. Although a number has been given to the desirability factor, it should be appreciated that the desirability may be rated according to any other suitable scale.

The employer 140 then enters the qualification requirements as shown in FIG. 18. FIG. 18 shows a screen shot 1800 of a qualification requirements web page according to an embodiment of the present invention. Qualifications may be a drivers license type, a building site safety certification, a first aid certification, and any other assessments or inductions that may be required, either general or specific to the employer 140. Similarly to the skills requirements, the qualification requirements may be given a desirability factor from 0 to 100, where 100 is a mandatory requirement and zero indicates a low desirability, or is outside of the scope of the system.

In addition, the employer 140 may add any special requirements, questions or notes relating to the job such as critical schedules, lunch arrangements, rest requirements and one way trips (requiring that the worker 130 find their own way home). In addition, the employer 140 may add any further questions that are not part of the scope of the system. Some of these questions may require an acknowledgement from the worker 130 that he or she understands the requirement or question. In addition, the employer 140 may set some default requirements relating to all jobs that the employer 140 posts, such as a company specific induction.

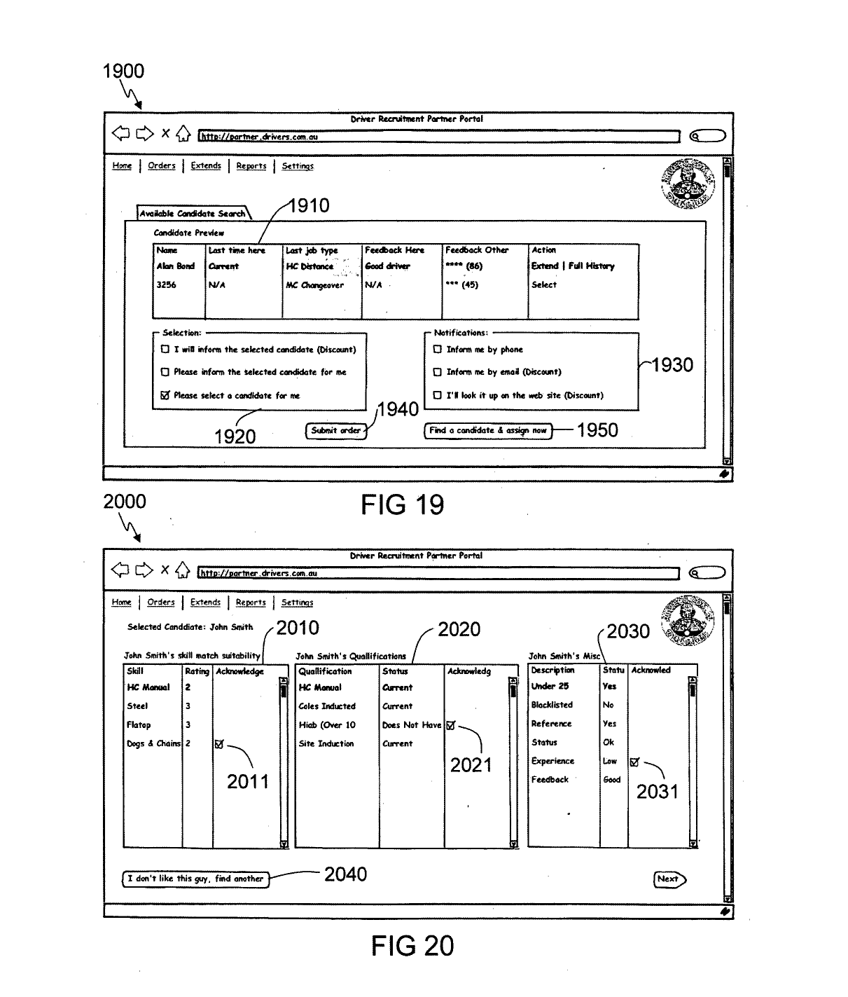

Once the employer 140 has entered a new job, the job is stored with job attributes on the server 120. The employer 140 is then presented with a list of workers 130 selected by the server whose profile matches the job attributes as shown in FIG. 19. Similar to a worker 130 finding a job, the server 120 may display suitable workers 130 at any stage of entering the requirements for the job, for example suitable workers 130 may be displayed once the skills have been entered in FIG. 17.

FIG. 19 shows a screen shot 1900 of a worker match web page according to an embodiment of the present invention. In order to see more details of the worker 130, the employer 140 may click on the worker 130 in table 1910 to see the worker's full profile. The workers 130 are displayed in order of whose profile most closely matches the job requirements. However, it should be appreciated that the workers 130 may be displayed in any suitable order such as by a level of feedback.

FIG. 20 shows a screen shot a worker's full profile. The worker's full profile may show a skills table 2010, a qualifications table 2020 and a table of miscellaneous details 2030.

The skills table 2010 may show a rating of the worker's skill level and experience according to a sliding scale, such a 1 to 5, where 5 is the highest rating and 1 is the lowest rating. The rating may be calculated based on answers to the interview questions from the worker profile.

The miscellaneous details table 2030 may include a level of experience, completed inductions (not shown), feedback from previous employers and a photo (not shown).

If an employer 140 does not want to select the current worker 130, the employer 140 clicks on a find another worker button 2040 and the employer 140 may select another worker 130 from the screen of FIG. 19.

Referring back to FIG. 19, once the employer 140 has selected a worker 130 or workers 130, the employer 140 chooses how to contact the worker 130 using a contact box 1920. For example, the employer 140 may contact the worker 130, the managing agency 150 may contact the worker 130, or the managing agency 150 may select and contact the worker 130. Discounts may be applied to a managing agency fee if the employer 140 decides to contact the worker 130 as less input is required from the managing agency 150.

The employer 140 then selects how they wish to be notified of the appointment of the worker 130 from a notification box 1930. Similarly to the selection process, the managing agency 150 may notify the employer 140 by phone, by email, text message or by the employer 140 logging onto the website. Similarly, the worker 130 may respond by sending a text message or contacting the employer by phone or email. Again discounts may apply where human interaction with the managing agency 150 is not involved.

Once the relevant selections have been made, the employer 140 may press a submit order button 1940 to place an order for a worker 130. Alternatively the employer 140 may click on a find and assign worker button 1950, which sends a request to the managing agency 150 to select and place each worker 130. Once confirmed, the employer 140 may pay a fee to the managing agency 150, thus releasing contact details of the worker 130 to allow the employer 140 to contact the worker 130 directly.

Once the worker 130 has been assigned to a job, the server 120 may send a confirmation email to the employer 140. The confirmation email may include the details of the job order together with a full CV of the worked 30.

When a selected worker 130 has completed a job for the employer 140, the worker 130 may have a physical timesheet signed by a representative of the employer 140, or alternatively or in addition to having the timesheet, the worker 130 may enter his or her start and finish times into the website. In one embodiment, the start and finish times are automatically entered using RFID and cellular technology, for example a time clock system. Alternatively, the start and finish times may be manually entered on the website by the employer 140 or the worker 130.

In addition, the worker 130 may provide feedback on the employer 140. For example, the worker 130 may provide feedback on safety and payment for example.

Once the employer 140 confirms the start and finish times of the worker 130, the managing agency 150 pays the worker 130 and invoices the employer 140. In addition, the employer 140 may, for example, view, print, authorise invoices and view previous candidates, and approve or disapprove an invoice total or a plurality of invoices. Furthermore, the invoices may be updated in real time depending on discounts that may apply when certain volumes have been reached, for example, as detailed below.

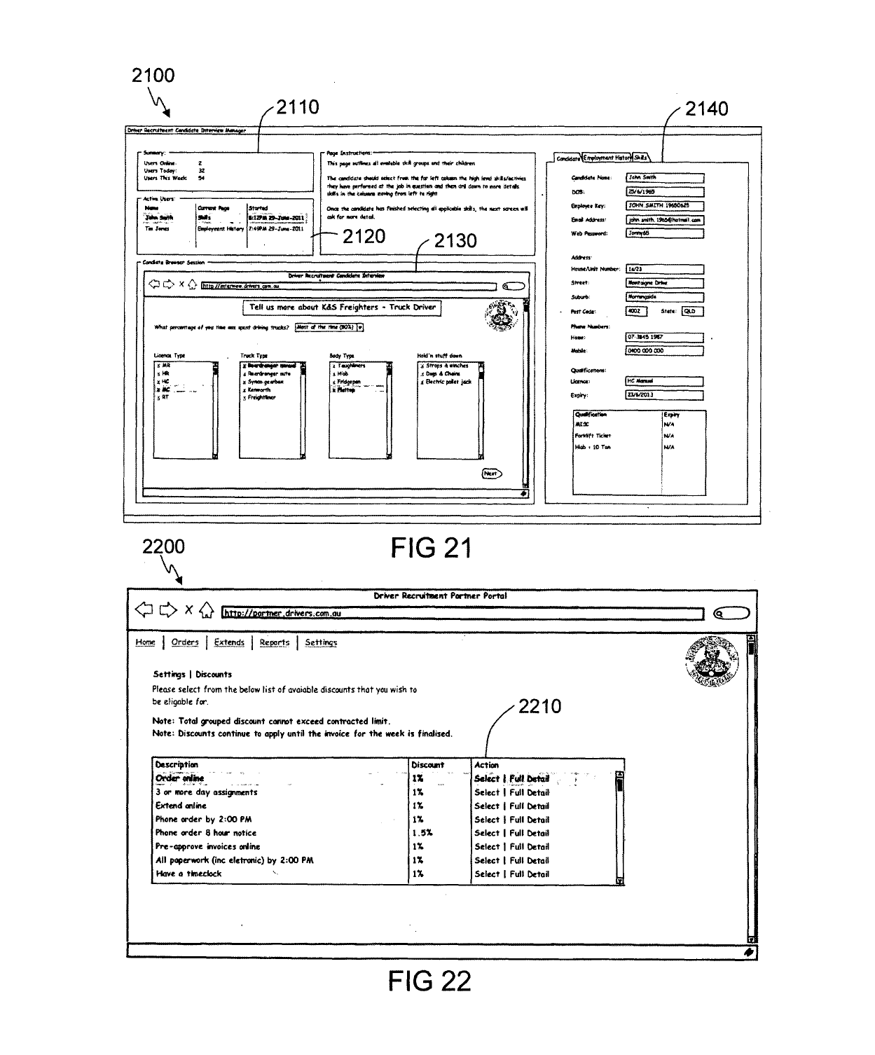

The employer 140 or the managing agency 150 may need to interact with the worker 130 during the interview or the induction. FIG. 21 shows a screen shot 2100 of an interactive web page according to an embodiment of the present invention. The interactive web page shows the number of users 2110 logged into the system at one time. A list 2120 provides names of the workers 130 currently logged in, together with a name of the web page they are currently viewing and a time they have been logged in. By clicking on a name in the list 2120, the employer 140 or managing agency 150 may view a screen shot of the web page that the worker 130 is currently viewing, and some details of the worker's user profile 2140.

As previously mentioned, discounts are provided to the managing agency fee by performing as much, of the worker 130 selection and placement process via the website, as possible. FIG. 22 shows a screenshot 2100 of a pricing structure web page according to an embodiment of the present invention. A discount table 2210 may be displayed to the employer 140 illustrating the discounts available. Some exemplary discounts are applied for placing orders via the website, volume orders and extending a contract on-line.

Further discounts may be provided by pre-authorising invoices. For example, the employer 140 agrees to an hourly rate and a number of hours to be worked. Anything falling outside the agreed limits would need approval.

Furthermore, pay codes may be automatically calculated per day, and a discount may be displayed in real time as the worker's clock on and off times are signed off by the employer 140. In addition, pay rates and charges may be calculated using pre-defined rules linked to a pay award as appropriate. For example the rules may set normal rates and overtime rates and when these rates should be applied.

In one embodiment, the interview questions are manually tailored by the managing agency 150. However it should be appreciated that some questions may be automatically selected by resume parser software installed on the server 120, for example when drilling down a profession. For instance, the worker 130 may select “driver”. The parser software may return types of driver, for example a truck driver, a taxi driver, or a bus driver, and the worker 130 selects the most relevant profession.

In addition, the resume parser may identify skills from the resume, such as driver, dentist and denture modelling. The resume parser may then pre-populate fields with the identified skills. From the skills identified by the resume parser, the server 120 may then identify further skills, as outlined previously.

In addition, the system of the present invention may learn from interviews performed with other workers 130. This may reveal other skills and experiences not normally associated with a particular profession. For example, in previous interviews on a plurality of workers 130 for a driver, the server 120 may determine that a pre-determined number workers 130 also have experience using photocopiers. Thus the server 120 may suggest the further skill of using photocopiers to add to the worker's 130 profile.

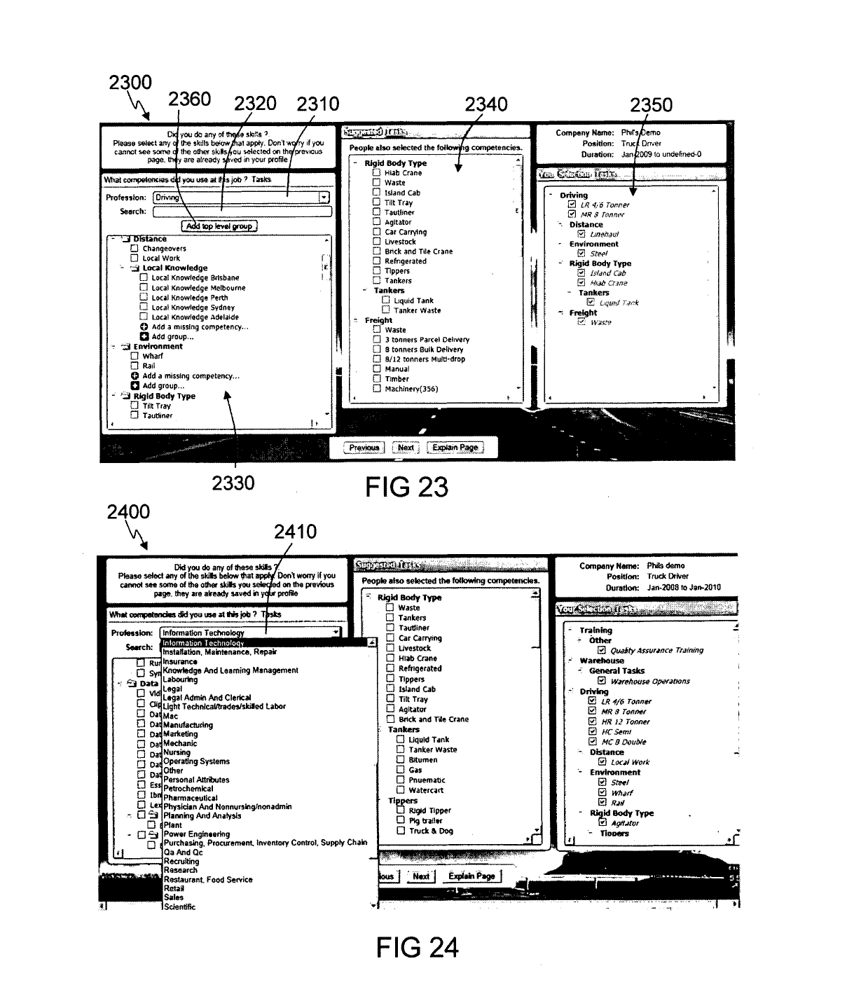

FIG. 23 shows a screen shot 2300 of an alternative embodiment of a skills selection web page. The web page is similar to the web pages shown in FIGS. 5 to 10. However, in this embodiment, the worker 130 selects a profession from a drop down list 2310 that he or she performed at the employer 140 entered in the employment web page of FIG. 4. Alternatively, the worker 130 may enter key words into a search box 2320. The worker 130 may select the most relevant profession or professions from a drop down list 2410 as shown in FIG. 24. The server 120 determines skills associated with the selected profession and sends a list 2330 of the skills to be displayed to the worker 130. The worker 130 may select applicable skills using checkboxes for example.

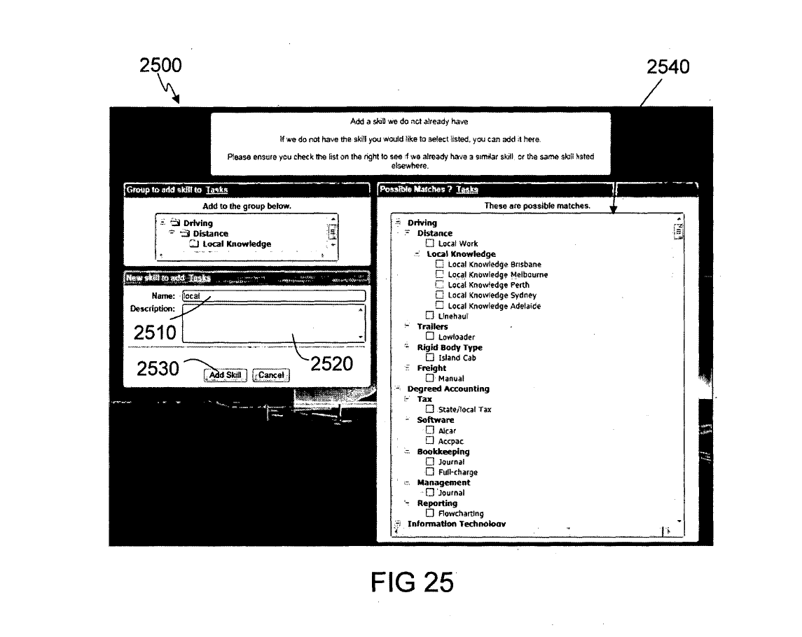

Furthermore, if a skill, profession or qualification is not listed, a worker 130 or an employer 140 or any other user, may add a skill to the database stored on the server 120 by clicking on an add skill button 2360 shown in FIG. 23. FIG. 25 shows a screen shot 2500 of an add skill web page according to an embodiment of the present invention. As shown in FIG. 25, the user enters a name 2510 for the new skill and a description 2520 of the new skill. From the name 2510 and the description 2520, the server 120 determines whether the new skill is currently in the database, or closely matches an existing skill in the database, and displays the existing skills to the user in a list 2540. If the skill does not exist, the user clicks on an add new skill button 2530.

In another embodiment, the worker 130, the employer 140 or any other user has the ability to edit or add descriptions of the skill, profession and qualifications, Users may also upload mages or videos detailing how to operate a phone system for example.

Once the applicable skills have been selected by the worker 130, the server 120 may determine further skills that other workers 130 in the same profession have previously selected during an interview process using the present invention. The server 120 sends a list 2340 of suggested skills for displaying to the worker 130. These skills may be totally unrelated to the selected profession. For example, the server 120 may determine that a number of workers 130 in the driving profession also have photocopying skills. Thus photocopying may be displayed to the worker 130 in the list 2340 of suggested skills. For example the server 120 may send the list 2340 if two or more previous workers 130 performing the interview, and in the driving profession have also selected photocopying as a skill.

Once all skills have been selected by the worker 130, the selected skills are shown in a list 2350 of selected skills. The worker 130 may make amendments to the list by checking or un-checking a respective tick box. Once all relevant selections have been made by the worker 130, the selections are saved to the worker profile.

In some embodiments, the worker 130 may also answer questions on a job they would like to do and the server 120 will send questions to the worker 130 based on this type of job. This type of job may not relate to previous skills but allows the worker 130 to choose skills or jobs he or she would like to be considered for. Many employers train people with no experience for some tasks. Many employers will take workers with certain skills, x and y for example, and train them for another skill z for example.

In summary, some advantages of the present invention include:

1) Interview questions are tailored, either by the managing agency or by another entity, to gather the required level of detail for a particular type of job;

2) The employer does not need invest significant valuable time to determine the right questions to ask the worker;

3) The system has artificial intelligence and prompts the client from a skill linking table, so if skill A is requested, skill B or C must be part of the process, or Qualification A or B is required. The skill linking table may be pre-defined or may be determined from answers provided previously by other workers 130;

4) The worker does not need substantial CV preparation skills concerning how much detail to include in their application;

5) The worker is assessed based on the answers provided to the interview questions;

6) Any inductions may be performed on-line to ensure that the worker is job ready;

7) The employer may save money by choosing to contact the worker directly and communicate with the managing agency electronically;

8) Workers possessing the right skills and qualifications, and having performed any necessary inductions, may be found more quickly and at shorter notice; and

9) The system can determine skills that may be unrelated to a profession using skills selected by other workers using the system. Thus the present invention may be able to fill jobs at short notice that could not previously have been filled. This is because a greater amount of information is gathered from the worker relating to other experiences rather than relating to a single task in order to determine the appropriate skills.

It should be appreciated that although reference is recruitment for the truck driving industry, various alternative embodiments of the present invention may be applied to any applicable industry such as, but not limited to, nursing, building and engineering.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. Accordingly, this patent specification is intended to embrace all alternatives, modifications and variations of the present invention that have been discussed herein, and other embodiments that fall within the spirit and scope of the above described invention.

1. A method of determining worker skills and experience comprising:
transmitting from a server a first interview question to a worker based on a job type;
receiving at the server an answer to the first interview question;
transmitting from the server a further interview question to the worker based on both the job type and the answer to the first interview question;
receiving at the server an answer to the further interview question; and
storing on the server the answer to the first interview question and the answer to the further interview question in a worker profile.

2. The method of claim 1 wherein the first and further interview questions are related to one or more of a skill, a qualification and an experience of the worker.

3. The method of claim 1 further comprising matching a job based on the worker's previous experience.

4. The method of claim 1 wherein a rating is applied to the worker profile based on answers to the interview questions.

5. The method of claim 1 further comprising matching job attributes to a worker profile at the server, and transmitting from the server one or more worker profiles that most closely match the job attributes.

6. The method of claim 5 wherein the job attributes include a qualification and a skill required for a job.

7. The method of claim 1 further comprising performing an induction on-line.

8. The method of claim 7 wherein a record of the induction is stored in the worker profile.

9. The method of claim 1 further comprising performing a skills assessment based on the answers to the first and further interview questions.

10. The method of claim 9 further comprising determining further skills based on interviews performed with other workers in the same profession and sending a list of suggested skills to the worker.

11. A system for determining worker skills and experience comprising:
a server connected to the internet, the server comprising:
a memory coupled to a processor, wherein the memory includes computer readable program code components configured to cause:
transmitting a first interview question to a worker based on a job type;
receiving an answer to the first interview question;
transmitting a further interview question to the worker based on both the job type and the answer to the first interview question;
receiving an answer to the further interview question; and
storing the answer to the first interview question and the answer to the further interview question in a worker profile.

12. The system of claim 11 wherein the first and further interview questions are related to one or more of a skill, a qualification and an experience of the worker.

13. The system of claim 11 wherein the program code components further comprise matching a job based on the worker's previous experience.

14. The system of claim 11 wherein a rating is applied to the worker profile based on answers to the interview questions.

15. The system of claim 11 wherein the program code components further comprise matching job attributes to a worker profile at the server, and transmitting from the server one or more worker profiles that most closely match the job attributes.

16. The system of claim 15 wherein the job attributes include a qualification and a skill required for a job.

17. The system of claim 11 wherein the program code components further comprise performing an induction on-line.

18. The system of claim 17 wherein a record of the induction is stored in the worker profile.

19. The system of claim 11 wherein the program code components further comprise performing a skills assessment based on the answers to the first and further interview questions.

20. The system of claim 19 wherein the program code components further comprise determining further skills based on interviews performed with other workers in the same profession and sending a list of suggested skills to the worker.
